(19) United States
(12) Patent Application Publication
(10) Pub. No.: US 2003/0049000 A1
(43) Pub. Date: Mar. 13, 2003

(54) Transceiver module with an unlocking device

(76) Inventor: Hung-Yi Wu, Chi-Lung City (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,969

(22) Filed: Sep. 5, 2002

(30) Foreign Application Priority Data
Sep. 7, 2001 (TW) 090122196

(51) Int. Cl. G02B 6/42

(52) U.S. Cl. 385/92

(57) ABSTRACT

A transceiver module for a fiber-optic communications system is provided. The transceiver module includes a socket, a transceiver for inserting into the socket, a locking device for fixing the transceiver with the socket, and an unlocking device rotatably installed on the transceiver for releasing the locking device. When the unlocking device is rotated, the locking device is released so the transceiver can be pulled out of the socket.

### BACKGROUND OF INVENTION

1. Field of the Invention

The present invention relates to a transceiver module used in a fiber-optic communications system, and more particularly, to a transceiver module with an unlocking device that can be released by depressing a depressor.

2. Description of the Prior Art

In recent years, fiber-optic communications technology has seen tremendous growth and advancement. Since the frequency of light waves is higher than the frequency of radio waves, systems utilizing light as a carrier wave have broader bandwidth for transmitting information and messages.

Please refer to FIG. 1, which shows a schematic diagram of a transceiver module 10 for a fiber-optic communications system according to the prior art. The transceiver module 10 includes a socket 14 installed on a communications system 34, and a transceiver 12 for inserting into the socket 14. The transceiver 12 transforms optical signals from a fiber-optic cable 32 into corresponding electric signals for transmission to the communications system 34. The transceiver 12 also transforms electric signals from the communications system 34 into corresponding optical for transmission to the fiber-optic cable 32. The transceiver module 10 further includes a locking device 16 for attaching the transceiver 12 to the socket 14. The locking device 16 includes an elastic piece 18 installed on the socket 14, and a slider 20 installed on the transceiver 12. The slider 20 is capable of sliding on the transceiver 12 so as to contact the elastic piece 18. When a protrusion 24 on the slider 20 fits into an opening 26 within the elastic piece 18, the transceiver 12 is locked in the socket 14.

Please refer to FIG. 2A through FIG. 2C, which show schematic diagrams of an unlocking operation of the transceiver module 10. When a user wants to pull the transceiver 12, which is inserted and locked in the socket 14 (as shown in FIG. 2A), out of the socket 14, he pushes the slider 20 forward (following arrow 30 in FIG. 2B), uses a slope 28 to lift the elastic piece 18 above the protrusion 24 so as to separate the protrusion 24 from the opening 26, and pulls the transceiver 12 backwards to separate the entire transceiver 12 from the socket 14 (as shown in FIG. 2C).

However, the unlocking design of the transceiver module 10 has its disadvantages. When the user pushes the slider 20 forward, he has to simultaneously pull the transceiver 12 backward in order to release the coupling between the transceiver 12 and the socket 14. This design does not follow the principles of good ergonomics, as it does not provide an intuitive and convenient way for the user to unlock the locking device.

### SUMMARY OF INVENTION

It is therefore an objective of the claimed invention to provide a transceiver module with an unlocking device that can be released by depressing a depressor to solve the above-mentioned problem.

According to the claimed invention, the transceiver module includes a socket, a transceiver for inserting into the socket, a locking device for attaching the transceiver to the socket, and an unlocking device rotatably installed on the transceiver for releasing the locking device. An optical device is installed within the transceiver for transmitting and receiving photoelectric signals. The locking device includes afirst coupling mechanism installed on the socket and a second coupling mechanism installed on the transceiver for coupling with the first coupling mechanism. The unlocking device has a first end for moving the first coupling mechanism. When the unlocking device is rotated, the first end will move the first coupling mechanism and release the coupling between the first and the second coupling mechanisms so that the transceiver can be pulled out from the socket.

It is an advantage of the present invention that the transceiver module has a rotating unlocking device on the transceiver. When a user wants to separate the transceiver from the socket, he can use his thumb and forefinger to pinch the transceiver and easily pull the transceiver out.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a transceiver module used in a fiber-optic communications system according to the prior art.

FIG. 2A to FIG. 2C are schematic diagrams of an unlocking operation of a transceiver module according to the prior art.

FIG. 3 is a perspective view of a transceiver module used in a fiber-optic communications system according to the present invention.

FIG. 4 is an exploded view of the transceiver module shown in FIG. 3.

FIG. 5A to FIG. 5C are schematic diagrams of a locking operation of the transceiver module shown in FIG. 3.

FIG. 6A to FIG. 6C are schematic diagrams of an unlocking operation of the transceiver module shown in FIG. 3.

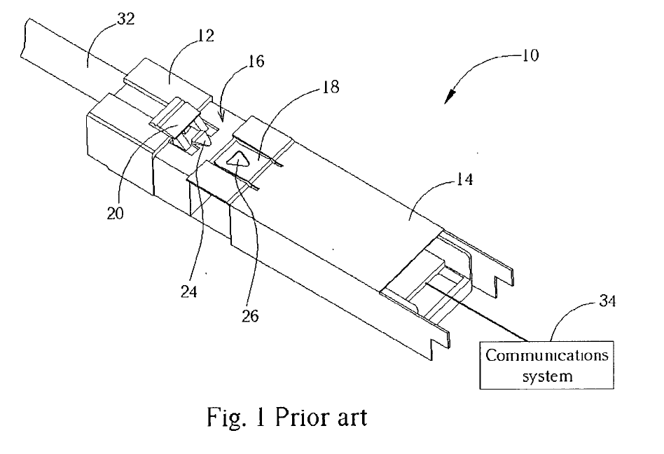

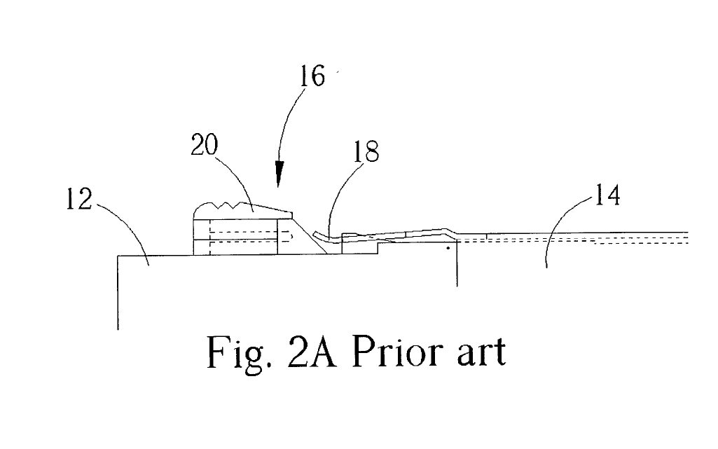

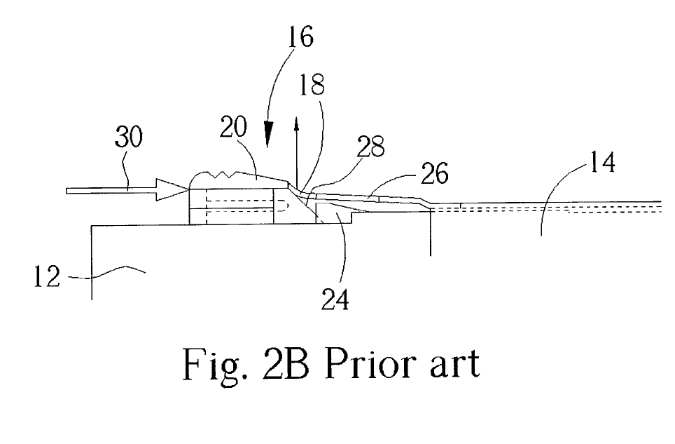

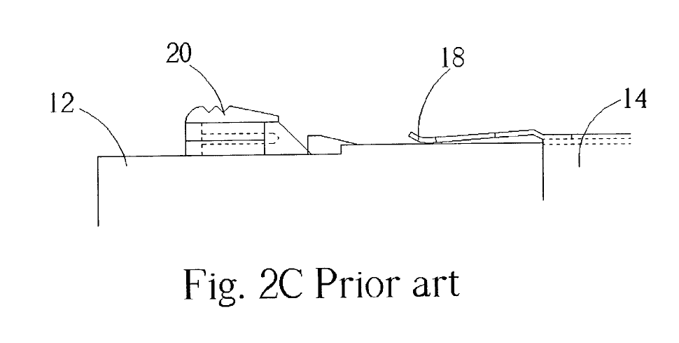

### DETAILED DESCRIPTION

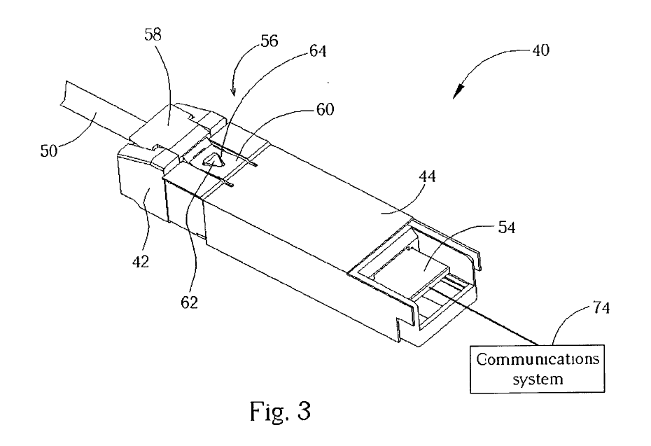

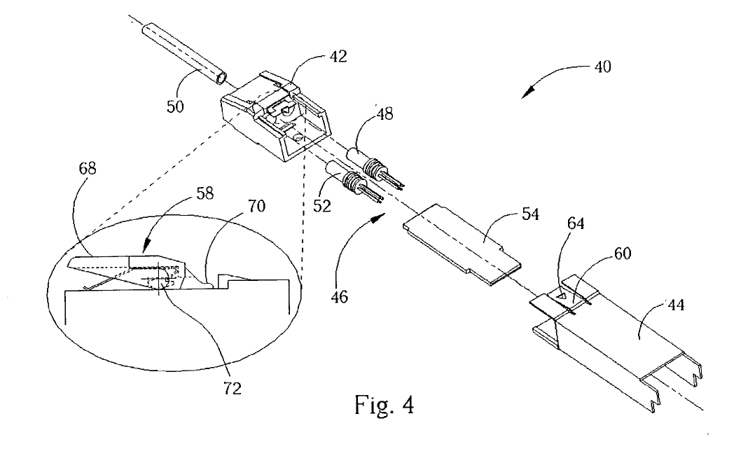

Please refer to FIG. 3 and FIG. 4. FIG. 3 is a perspective view of a transceiver module 40 using in an optical fiber communications system according to the present invention, and FIG. 4 is an exploded view of the transceiver module 40. The transceiver module 40 comprises a socket 44 installed on a communications system 74, and a transceiver 42 used to insert into the socket 44 to connect to the communications system 74. The transceiver 42 comprises an optical device 46 (as shown in FIG. 4) for processing photoelectric signals. The optical device 46 comprises an optical emitter 48 connected to a fiber-optic cable 50 for emitting optical signals and an optical receiver 52 connected to the fiber-optic cable 50 for receiving optical signals. Inside the socket 44, a printed circuit board (PCB) 54 is installed to drive the optical emitter 48 to generate optical signals and process optical signals received by the optical receiver 52. Therefore, the transceiver 42 is capable of transforming optical signals from the fiber-optic cable 50 into corresponding electric signals for transmission to the communications system 74. The transceiver 42 is also capable of transforming electric signals from the communications system 74 into corresponding optical for transmission to the fiber-optic cable 50.

As shown in FIG. 3, the transceiver module 40 further includes a locking device 56 for fixing the transceiver 42 in the socket 44, and an unlocking device 58 rotatably installed on the transceiver 42 for releasing the locking device 56 and separating the transceiver 42 from the socket 44. The locking device 56 includes a first coupling mechanism 60 installed on the socket 44 and a second coupling mechanism 62 installed on the transceiver 42 for engaging with the first coupling mechanism 60. The first coupling mechanism 60 is an elastic piece with an opening 64 therein, and the second coupling mechanism 62 is a protrusion protruding from a surface of the transceiver 42 for fitting in the opening 64.

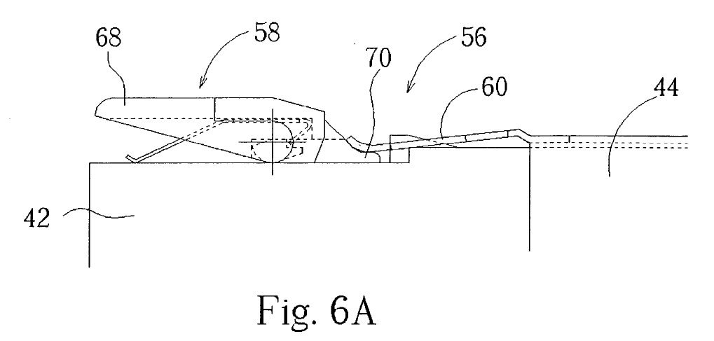

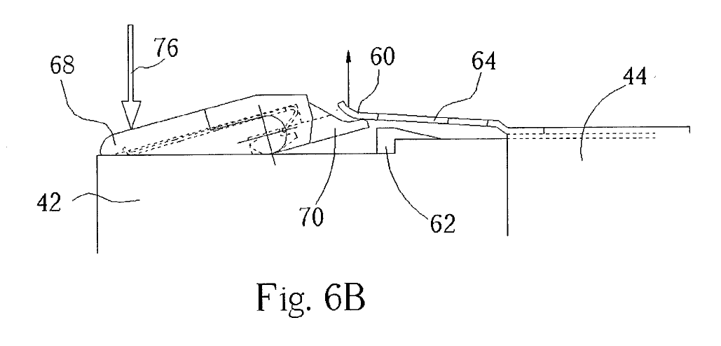

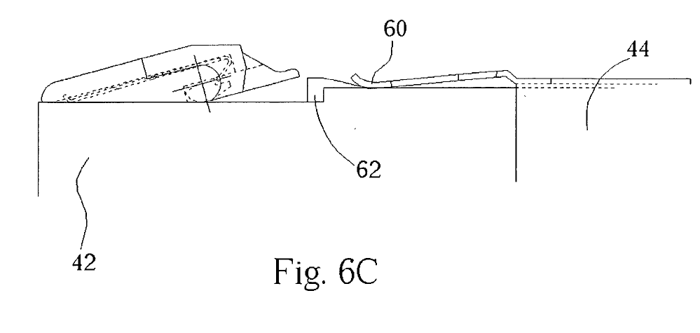

As shown in FIG. 4, the unlocking device 58 includes a depressor 68 provided for a user to press, a front end 70 for moving the first coupling mechanism 60, and a rotator 72 installed between the front end 70 and the depressor 68. The unlocking device 58 is used to release the locking device 56 (including the elastic piece 60 and the protrusion 62). The releasing operation is illustrated in FIG. 6A to FIG. 6C.

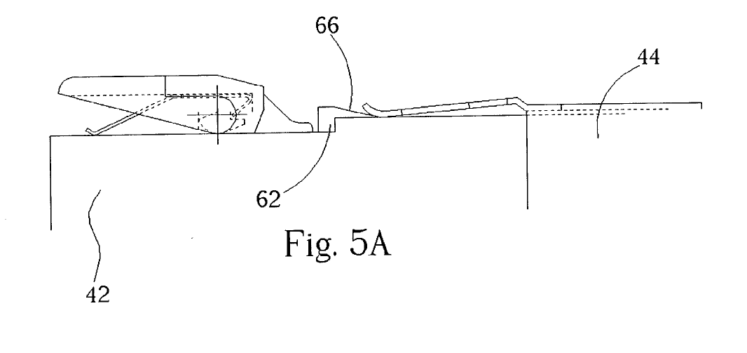

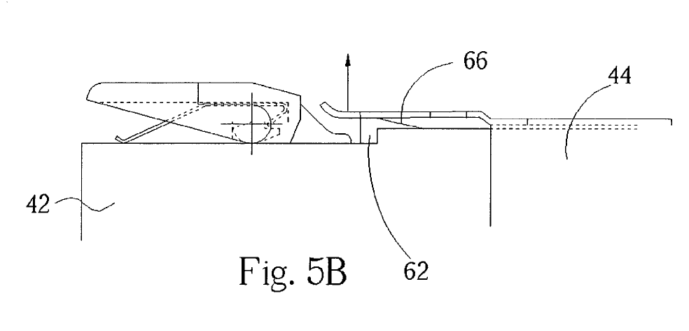

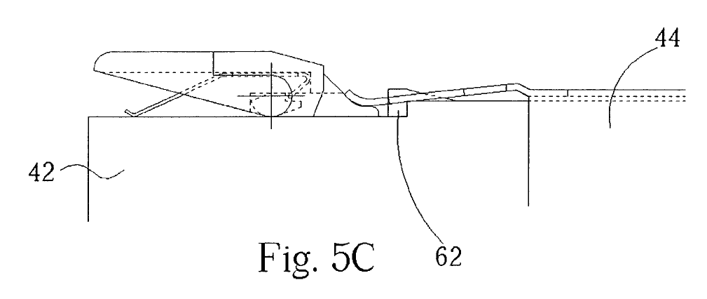

Please refer to FIG. 5A to FIG. 5C, which show schematic diagrams of a locking operation of the transceiver module 40. When a user wants to attach the transceiver 42 to the socket 44, he plugs the transceiver 42 into the socket 44 and pushes the transceiver 42 forward (to the right side as shown in FIG. 5A) so as to use a slope 66 of the protrusion 62 to lift the elastic piece 60 upward (as shown in FIG. 5B). Following the forward movement of the transceiver 42, the protrusion 62 slides into the opening 64 to lock with the elastic piece 60 (as shown in FIG. 5C), thus completing the locking operation and fixing the transceiver 42 in the socket 44.

Please refer to FIG. 6A to FIG. 6C, which show schematic diagrams of an unlocking operation of the transceiver module 40. When a user wants to separate the transceiver 42, which is fixed in the socket 44 (as shown in FIG. 6A), from the socket 44, he can use the depressor 68 of the unlocking device 58 to release the locking device 56. When the depressor 68 is pressed downward (following an arrow 76 in FIG. 6B), the unlocking device 58 is rotated to raise the front end 70. This lifts the elastic piece 60 above the protrusion 62 and separates the elastic piece 60 from the protrusion 62. As a result, the coupling between the protrusion 62 and the opening 64 is released, and the transceiver 42 is capable of moving out of the socket 44. The user pulls the transceiver 42 backwards (as shown in FIG. 6C) to free the transceiver 42 from the socket 44.

In contrast to the prior art transceiver module 10, the transceiver module 40 of the present invention has the unlocking device 58 rotatably installed on the transceiver 42. Therefore, when a user wants to separate the transceiver 42 from the socket 44, he can use his thumb to press the depressor 68 and easily pull the transceiver 42 out. In addition, cost for manufacturing the transceiver module 40 of the present invention is almost the same as the transceiver of the prior art, thus the product of the present invention is superior in competition.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A transceiver module for a fiber-optic communications system comprising:
a socket;
a transceiver for inserting into the socket, the transceiver having an optical device for processing photoelectric signals;
a locking device for securing the transceiver in the socket, the locking device having a first coupling mechanism installed on the socket and a second coupling mechanism installed on the transceiver for engaging with the first coupling mechanism; and
an unlocking device rotatably installed on the transceiver for separating the first and second coupling mechanisms of the locking device, the unlocking device having a first end for moving the first coupling mechanism;
wherein when the unlocking device is rotated, the first end will move the first coupling mechanism to release the second coupling mechanism from the first coupling mechanism so that the transceiver is capable of being pulled out of the socket.

2. The transceiver module of claim 1 wherein the unlocking device further comprises a second end and a pivot formed between the first end and the second end, and when the second end is pushed downward, the first end will move upward so that the transceiver is capable of being pulled out of the socket.

3. The transceiver module of claim 1 wherein the first coupling mechanism is an elastic piece with an opening, the second coupling mechanism is a protrusion protruding from a surface of the transceiver, and when the unlocking device is rotated, the first end will push the elastic piece upward so that the transceiver is capable of being pulled out of the socket.

4. The transceiver module of claim 3 wherein when inserting the transceiver into the socket, the protrusion will lift up the elastic piece and will fit into the opening so as to connect the transceiver with the socket.

5. The transceiver module of claim 1 wherein the optical device comprises an optical emitter connected to a fiber-optic cable for emitting optical signals and an optical receiver connected to the fiber-optic cable for receiving optical signals, the transceiver module further comprising a printed circuit board disposed inside the socket for driving the optical emitter to generate optical signals and processing optical signals received by the optical receiver.
